(19) United States
(12) Patent Application Publication
(10) Pub. No.: US 2026/0192792 A1
(43) Pub. Date: Jul. 9, 2026

(54) COLD START HYBRID SYSTEM FOR AUTOMOTIVE HYDROGEN FUEL CELL PACKS

(71) Applicant: International Truck Intellectual Property Company, LLC, Lisle, IL (US)

(72) Inventors: Alex Mack, Hinsdale, IL (US); Paul L. Berke, Chicago, IL (US); Stephen Lawrence Kadolph, Darien, IL (US); Louis Maza, Plainfield, IL (US); Steven Joseph Dickerson, Lake in the Hills, IL (US); Andrei Makartchouk, Hinsdale, IL (US)

(73) Assignee: International Truck Intellectual Property Company, LLC, Lisle, IL (US)

(21) Appl. No.: 19/013,284

(22) Filed: Jan. 8, 2025

(51) Int. Cl. B60W 20/15; B60W 10/06; B60W 10/28; F01N 5/02; F01N 13/08; F02D 41/02

(52) U.S. Cl. CPC B60W 20/15; B60W 10/06; B60W 10/28; F01N 5/02; F01N 13/08; F02D 41/021; B60W 2510/285; F02D 2200/50

(57) ABSTRACT

A cold start hybrid system combines an internal combustion engine and a hydrogen fuel cell pack. Specifically, under extreme cold ambient temperatures, the internal combustion engine may be utilized to both run the vehicle and supply heat to the hydrogen fuel cell pack during the hydrogen fuel cell pack's initialization at cold start. Upon reaching appropriate temperatures for operating conditions, the system will switch from the internal combustion engine to the hydrogen fuel cell pack.

### TECHNICAL FIELD

A cold start hybrid system combines an internal combustion engine and a hydrogen fuel cell pack. Specifically, under extreme cold ambient temperatures, the internal combustion engine may be utilized to both run the vehicle and supply heat to the hydrogen fuel cell pack during the hydrogen fuel cell pack's initialization at cold start. Upon reaching appropriate temperatures for operating conditions, the system will switch from the internal combustion engine to the hydrogen fuel cell pack.

### BACKGROUND

Currently, for heavy duty automotive applications, after cold overnight soak, it is very time-consuming and challenging for a hydrogen fuel cell pack to get back to operation. The pack is typically deeply frozen, and the intake air is cold and frosty. From the very first moment of the hydrogen fuel cell pack's activation, water begins accumulating in the pack and becomes iced. As more water is generated, higher levels of ice accumulate in the ice pack, causing the hydrogen fuel cell pack to lose efficiency and reduce voltage. Thus, the hydrogen fuel cell pack loses capacity to self-regenerate heat and the hydrogen cell goes into sleep.

FIG. 1 illustrates an operation of a hydrogen fuel cell pack at −20° C., showing time of activation of an automotive hydrogen fuel cell pack over time, showing voltage of the hydrogen fuel cell pack during the operation thereof as the temperature of the hydrogen fuel cell pack increases. Specifically, as shown in FIG. 1, it takes about 20 minutes to warm up the cells of the hydrogen fuel cell pack from −20° C. to about 0° C. using a typical external heating system that supplies the flow of 12° C. antifreeze to the hydrogen fuel cell pack. As further illustrated in FIG. 1, the voltage dropped throughout the warm-up process. Thus, under extreme cold of −30° C. or −40° C., it is likely that the existing automotive hydrogen fuel cell pack system will be unable to achieve normal operation. A need, therefore, exists for an improved hydrogen fuel cell pack system. Specifically, a need exists for a hybrid system for both running the vehicle and for supplying heat to the hydrogen cells of the hydrogen fuel cell pack. More specifically, a need exists for a hybrid system that maintains efficiency and voltage of the hydrogen fuel cell packs, shortens startup time, achieves a faster, safer, and more effective cold start.

### SUMMARY

A cold start hybrid system combines an internal combustion engine and a hydrogen fuel cell pack. Specifically, under extreme cold ambient temperatures, the internal combustion engine is utilized to both run the vehicle and supply heat to the hydrogen fuel cell pack during the hydrogen fuel cell pack's initialization at cold start. Upon reaching appropriate temperatures for operating conditions, the system switches from the internal combustion engine to the hydrogen fuel cell pack for normal operation of the vehicle.

### BRIEF DESCRIPTION OF THE DRAWINGS

FIG. 1 illustrates a chart of an operation of a hydrogen fuel cell pack at −20° C., illustrating cell voltage drop as hydrogen fuel cell temperature increases.

FIG. 2 illustrates a cold start hybrid system for automotive fuel cell packs in an embodiment of the present invention.

FIG. 3 illustrates a flow chart for a cold start hybrid system for automotive hydrogen fuel cell packs in an embodiment of the present invention.

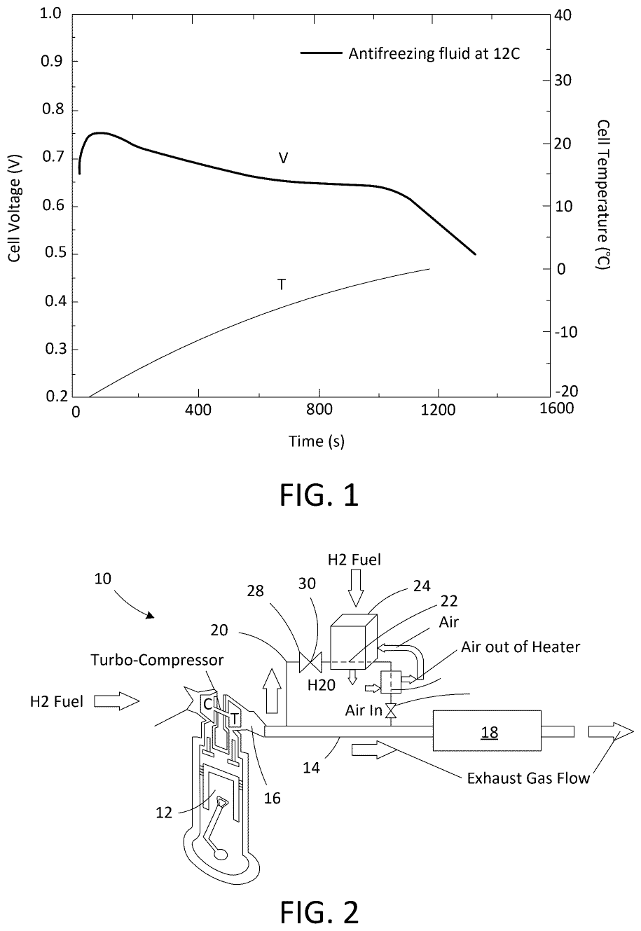

### DETAILED DESCRIPTION

A cold start hybrid system combines an internal combustion engine and a hydrogen fuel cell pack. Specifically, under extreme cold ambient temperatures, the internal combustion engine may be utilized to both run the vehicle and supply heat to the hydrogen fuel cell pack during the hydrogen fuel cell pack's initialization at cold start. Upon reaching appropriate temperatures for operating conditions, the system will switch from the internal combustion engine to the hydrogen fuel cell pack.

In an embodiment of the present invention, a cold start hybrid system 10 for automotive hydrogen cell packs is provided. The cold start hybrid system 10 comprises an internal combustion engine 12 that may run on hydrogen fuel or any other fuels, thereby generating heat exhaust. A heat exhaust pipe 14 may run from an exhaust manifold 16 of the internal combustion engine 12 for routing exhaust flow and, specifically, heat, therethrough to a muffler 18 and, ultimately, exhausted. The internal combustion engine 12 may be utilized to run the vehicle, especially at cold temperatures until a hydrogen fuel cell pack 24 is warmed-up via the system 10 provided herein.

An exhaust pipe branch 20 may extend from the exhaust pipe 14 and may lead to a hydrogen fuel cell pack heater 22 and/or to a hydrogen fuel cell pack intake air heater 26. A control valve 28 may be in-line with the exhaust pipe branch 20 that may control the flow of heat exhaust therethrough, which may be controlled by an engine control module (ECM) 30, which may further control all other engine components and systems. An optional check valve 32 may further be in-line with the exhaust pipe branch 20 to pass exhaust flow therethrough but check against returned exhaust flow. The exhaust pipe branch 20 may reconnect with the exhaust pipe, allowing exhaust flow to flow therethrough to the muffler 18.

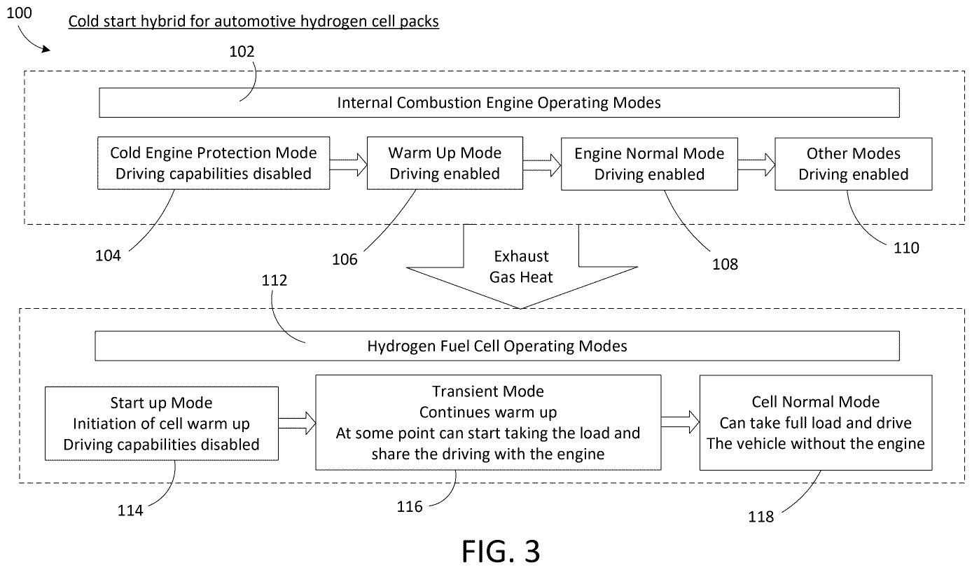

The cold start hybrid system 10 may utilized a plurality of “modes,” which may be implemented with the internal combustion engine 12 (“Internal Combustion Engine Operating Modes”) and/or with the hydrogen fuel cell pack 24 (“Hydrogen Fuel Cell Operating Modes”). FIG. 3 illustrates a flow chart 100 showing the use of various Internal Combustion Engine Operating Modes 102 and various Hydrogen Fuel Cell Operating Modes 112. One or more of the Internal Combustion Engine Operating Modes may be implemented in conjunction with one or more of the Hydrogen Fuel Cell Operating Modes for the most efficient use of the internal combustion engine 12 and/or the hydrogen fuel cell pack 24 in very cold temperatures.

In operation, which may occur when the ambient temperature is very cold or otherwise when the temperature of the hydrogen fuel cell pack 24 is below a first threshold temperature, the internal combustion engine 12 may be started, and the ECM 30 may employ a “cold engine protection operating mode” 104, as illustrated in FIG. 3. For example, in cold engine protection mode 104, the internal combustion engine 12 may be started at certain settings of engine hardware and RPM for several minutes to slightly warm the engine, thereby protecting the engine. During cold engine protection mode 104, a driver is preferably unable to drive the vehicle.

Once the cold ambient protection mode is complete, the ECM 30 may employ a “warm up mode” 106 during which the engine may allow a driver to engage the vehicle and drive the same. Warm up mode 106 may utilize the internal combustion engine 12 to supply power to the vehicle and further to provide heat exhaust through the system 10, as illustrated in FIG. 2, to warm up the hydrogen fuel cell pack 24. The warm up mode 106 may be engaged, for example, until the coolant temperature has reached the threshold for its normal operating temperature, thereby implementing “engine normal mode” 108.

During engine warm up mode 106 and engine normal mode 108, the ECM 30 may open the control valve 28 and the hot exhaust gas that may be generated by the internal combustion engine 12 may flow through the exhaust pipe branch 20 to the hydrogen fuel cell pack 24. The hot exhaust gas may flow to the hydrogen fuel cell pack heater 22 and/or to the hydrogen fuel cell pack intake air heater 26, which may utilize the hot exhaust flow from the internal combustion engine 12 to warm the hydrogen fuel cell pack 24. Specifically, because the range of exhaust gas temperatures of the exhaust flow from the internal combustion engine 12 is typically above 150° C., the hydrogen fuel cell pack 24 and the hydrogen fuel cell intake air may become warmed sufficiently to operating temperatures even at extremely low ambient temperatures. Once the internal combustion engine 12 has warmed sufficiently, the “engine normal mode” 108 may be implemented, whereby the engine may be utilized with or without contribution from the hydrogen fuel cell pack 24 for driving the vehicle. Thereafter, other internal combustion engine modes 110 may further be implemented such as, for example, a “shut down” mode which may shut down the internal combustion engine 12 when the hydrogen fuel cell pack 24 is sufficiently warm and fully able to drive the vehicle.

As the hydrogen fuel cell pack 24 is warmed by the exhaust from the internal combustion engine 12, via the Internal Combustion Engine Operating Modes 102, described above, the ECM 30 may implement one or more Hydrogen Fuel Cell Operating Modes 112 to sufficiently warm up and safely and efficiently operate the hydrogen fuel cell pack 24. Specifically, a “start up mode” 114 may be initiated, at which the hydrogen fuel cell pack 24 is warmed due to the exhaust from the internal combustion engine 12, as described above. During start up mode 114, driving capabilities may be disabled until the hydrogen fuel cell pack 24 is sufficiently warm.

Once the hydrogen fuel cell pack 24 is sufficiently warm, the ECM 30 may switch or share load between the internal combustion engine 12 and the hydrogen fuel cell pack 24 via “transient mode” 116, which may utilize both the internal combustion engine 12 and the hydrogen fuel cell pack 24 together to share driving of the vehicle. At a certain point, the ECM 30 may determine that the hydrogen fuel cell pack 24 is sufficiently warm and may take on the full load of the vehicle thereby driving the vehicle without the internal combustion engine 12, thereby implementing “cell normal mode” 118.

Once the hydrogen fuel cell pack 24 is warmed via the hot exhaust flow of the internal combustion engine 12, such as to a temperature above a second threshold temperature sufficient for efficient activation and use of the hydrogen fuel cell pack 24, the ECM 30 may switch from the internal combustion engine 12 to the hydrogen fuel cell pack 24, thereby supplying power to and driving the vehicle via the hydrogen fuel cell 24 and not the internal combustion engine 12. When the ECM 30 switches to hydrogen fuel cell pack 24 exclusively, the internal combustion engine 12 may be disengaged from operation and shut down via one of the other modes 110, and the control valve 28 may be closed. The vehicle may then run exclusively via the hydrogen fuel cell pack 24 and not the internal combustion engine 12.

It should be noted that various changes and modifications to the presently preferred embodiments described herein will be apparent to those skilled in the art. Such changes and modifications may be made without departing from the spirit and scope of the present invention and without diminishing its attendant advantages. Further, references throughout the specification to “the invention” are nonlimiting, and it should be noted that claim limitations presented herein are not meant to describe the invention as a whole. Moreover, the invention illustratively disclosed herein suitably may be practiced in the absence of any element which is not specifically disclosed herein.

We claim:

1. A cold start hybrid system for automotive hydrogen cell packs comprising:
a vehicle;
a hydrogen fuel cell pack within the vehicle, wherein the hydrogen fuel cell pack is configured to provide power to drive the vehicle;
an internal combustion engine within the vehicle, wherein the internal combustion engine is configured to provide power to drive the vehicle, wherein the internal combustion engine further comprises a first exhaust pipe for exhausting exhaust flow therefrom; and
a second exhaust pipe, wherein the second exhaust pipe is configured to allow exhaust flow from the internal combustion engine to warm the hydrogen fuel cell pack.

2. The cold start hybrid system of claim 1 wherein the vehicle is a truck.

3. The cold start hybrid system of claim 1 wherein the second exhaust pipe branches from the first exhaust pipe.

4. The cold start hybrid system of claim 1 wherein the second exhaust pipe branches from the first exhaust pipe in front of the hydrogen fuel cell pack and reconnects with the first exhaust pipe behind the hydrogen fuel cell pack.

5. The cold start hybrid system of claim 1 further comprising:
a hydrogen fuel cell pack heater associated with the hydrogen fuel cell pack, wherein the hydrogen fuel cell pack heater is configured to accept exhaust flow from the internal combustion engine through the second exhaust pipe to warm the hydrogen fuel cell pack.

6. The cold start hybrid system of claim 1 further comprising:
a hydrogen fuel cell pack intake air heater configured to feed heated air to the hydrogen fuel cell pack, wherein the hydrogen fuel cell pack intake air heater is further configured to receive exhaust flow from the internal combustion engine through the second pipe.

7. The cold start hybrid system of claim 1 further comprising:
a hydrogen fuel cell pack heater associated with the hydrogen fuel cell pack, wherein the hydrogen fuel cell pack heater is configured to accept exhaust flow from the internal combustion engine through the second exhaust pipe to warm the hydrogen fuel cell pack; and
a hydrogen fuel cell pack intake air heater configured to feed heated air to the hydrogen fuel cell pack, wherein the hydrogen fuel cell pack intake air heater is further configured to receive exhaust flow from the internal combustion engine through the second pipe.

8. The cold start hybrid system of claim 1 wherein the internal combustion engine is configured to combust hydrogen fuel.

9. The cold start hybrid system of claim 1 further comprising:
a control valve in-line with the second exhaust pipe and configured to open and close thereby facilitating exhaust flow therethrough or preventing exhaust flow therethrough.

10. The cold start hybrid system of claim 1 further comprising:
an engine control module configured to control exhaust flow from the internal combustion engine to the hydrogen fuel cell pack.

11. The cold start hybrid system of claim 1 further comprising:
a check valve on the second exhaust pipe configured to block the return of exhaust flow therethrough.

12. The cold start hybrid system of claim 1 wherein the first exhaust pipe extends from an exhaust manifold on the internal combustion engine.

13. A method of using a cold start hybrid system for automotive hydrogen cell packs comprising the steps of:
providing a vehicle, a hydrogen fuel cell pack within the vehicle, wherein the hydrogen fuel cell pack is configured to provide power to drive the vehicle, an internal combustion engine within the vehicle, wherein the internal combustion engine is configured to provide power to drive the vehicle, wherein the internal combustion engine further comprises a first exhaust pipe for exhausting exhaust flow therefrom, and a second exhaust pipe, wherein the second exhaust pipe is configured to allow exhaust flow from the internal combustion engine to warm the hydrogen fuel cell pack;
activating the internal combustion engine;
routing exhaust flow from the internal combustion engine to the hydrogen fuel cell pack;
warming the hydrogen fuel cell pack with the exhaust flow from the internal combustion engine;
driving the vehicle using the internal combustion engine to supply power to the vehicle;
activating the hydrogen fuel cell pack to supply power to the vehicle from the hydrogen fuel cell pack;
deactivating the internal combustion engine.

14. The method of claim 13 further comprising the steps of:
providing an engine control module;
controlling the activation of the internal combustion engine and the hydrogen fuel cell pack with the engine control module.

15. The method of claim 13 further comprising the steps of:
activating the internal combustion engine when the temperature of the hydrogen fuel cell pack is below a first threshold temperature;
activating the hydrogen fuel cell pack when the hydrogen fuel cell pack is above a second threshold temperature; and
deactivating the internal combustion engine upon activation of the hydrogen fuel cell pack.
